(19) United States
(12) Patent Application Publication
(10) Pub. No.: US 2015/0014266 A1
(43) Pub. Date: Jan. 15, 2015

(54) REVOLVING TOWER CRANE

(71) Applicant: Liebherr-Werk Ehingen GmbH, Ehingen (DE)

(72) Inventors: Mikica Rafailovic, Ehingen (DE); Joachim Henkel, Holzgunz (DE); Helga Tolksdorf, Schelklingen (DE)

(21) Appl. No.: 14/325,205

(22) Filed: Jul. 7, 2014

(30) Foreign Application Priority Data
Jul. 9, 2013 (DE) 10 2013 011 489.6

(51) Int. Cl. B66C 23/16; B66C 23/42; B66C 23/70; B66C 23/88; B66C 23/36

(52) U.S. Cl. CPC B66C 23/16; B66C 23/88; B66C 23/365; B66C 23/701; B66C 23/42
USPC 212/176; 212/199; 212/299; 212/295

(57) ABSTRACT

The present disclosure relates to a mobile revolving tower crane with a crane tower consisting of individual lattice pieces and with a main arm that is articulated in a rockable manner to the tower via a rocking mechanism, or with a rockable tip, wherein the crane tower comprises a climbing device.

### CROSS REFERENCE TO RELATED APPLICATION

This application claims priority to German Patent Application No. 10 2013 011 489.6, entitled “Revolving Tower Crane,” filed Jul. 9, 2013, which is hereby incorporated by reference in its entirety for all purposes.

### TECHNICAL FIELD

The present disclosure relates to a mobile revolving tower crane with a crane tower consisting of individual lattice pieces and with a main arm and/or a rockable arm tip.

### BACKGROUND AND SUMMARY

Currently, different types of crane types exist. For example, revolving tower cranes are known that can be constructed either as top slewing cranes or also as bottom slewing cranes. This construction is designed for certain carrying loads, heights and high outreaches; however the use of the crane often turns out to be inflexible on account of the lack of mobility.

Telecranes or also lattice tower cranes are known as alternative crane types that can comprise a rockable main tele-arm with optional lattice tip or rocker tip. Also, there are lattice tower cranes with caterpillar undercarriages and lattice tower arms with rocking tips. In order to achieve a long lattice combination these cranes generally require a lot of space and a so-called derrick ballast. They cause correspondingly high transport costs and require a lot of space for the crane construction. These crane types are currently also available as mobile versions.

The present disclosure is concerned with the problem of presenting a crane concept that unites the advantages of the above-cited crane types.

This problem is solved by a mobile revolving tower crane according to the features of a crane tower comprising individual lattice pieces and with a main arm that is rockably articulated to the tower by a rocking mechanism. Alternatively, instead of the main arm a rockable tip can be mounted.

Furthermore, the mobile revolving tower crane comprises a carrier undercarriage that makes it possible to move the revolving tower crane and increases its mobility. The revolving tower crane comprises a climbing device for the flexible assembly of the revolving tower crane in accordance with the present disclosure. The climbing device is arranged on the lattice pieces of the tower. Ideally, the crane tower is built up to the desired length before the start of the crane work. If needed, the crane tower can be lengthened by the use of one or more lattice pieces in the vertical direction by the climbing device. During the crane work the actual lifting work can be interrupted in order to insert one or more lattice pieces into the crane tower for increasing the lift height.

The tower crane may be constructed as a bottom slewing crane.

According to an example embodiment the revolving tower crane can comprise at least one revolving platform. There is the possibility of arranging at least one revolving platform in the lower area of the tower, i.e., between the tower and the carrier undercarriage of the crane. Furthermore, at least one upper fixed revolving platform can be alternatively or additionally provided in the upper area of the tower, in particular on the tower peak. Ideally, the crane has exactly two revolving platforms, wherein a lower revolving platform is arranged between the carrier undercarriage and the tower and wherein an upper, fixed revolving platform is arranged on the tower peak. The upper, fixed revolving platform serves to receive the arm articulated in a rockable manner.

Ideally, at least one crane cabin can be fastened, in particular detachably by bolts, on the lower and/or upper revolving platform.

The upper and the lower revolving platforms are optionally not rotatable against one another so that the tower can rotate only together with the lower and the upper revolving platform about its longitudinal axis. The lower revolving platform can be rotatable relative to the undercarriage by a revolving roller crown. The upper revolving platform is permanently connected to the tower.

The connection between the lower revolving platform and the carrier undercarriage takes place by a quick connection. This allows a simple construction and disassembly of the crane construction. In this case the quick connection provided on the carrier undercarriage simply engages into the revolving crown of the lower revolving platform.

The upper, permanent revolving platform is permanently connected to the climbing device during the climbing procedure of the crane, in contrast to which during the lifting operation a fixed connection exists between the tower, i.e., the upper lattice element and the fixed revolving platform. The climbing device can remain above during the actual crane work or, however, can be let entirely down.

The crane drive technology and other crane components can be arranged completely or at least largely on the upper, fixed revolving platform. The lower revolving platform comprises a revolving platform drive that engages on the revolving crown for executing the rotary movement. The energy supply of this drive unit can take place via the drive mechanism or the hydraulic mechanism of the upper, fixed revolving platform. Necessary electrical and/or hydraulic connection lines then run along the longitudinal tower axis from the upper, fixed revolving platform to the lower one. The design of the supply lines is appropriately designed to be flexible in order to adapt them in an uncomplicated manner to the particular tower height. Supply lines for the hydraulic mechanism are wound, for example, on at least one hose roll that makes the required line length available during the climbing operation.

The comparatively large structural height of the upper, fixed revolving platform and of the crane drive mechanism can require the use of an extinguishing device on the upper revolving platform. To this end one or more extinguishing devices are provided on the upper revolving platform and in the area of the crane drive mechanism that can be selectively initiated manually by remote control or automatically.

Alternatively, the entire drive unit can also be arranged on the lower revolving platform. In this case the transfer of lines to the consumers into the upper, fixed revolving platform must be made by hoses, cables, etc.

The crane tower can be constructed from a plurality of identical or different lattice pieces that are bolted to each other. The lattice pieces can differ from each other as regards the material thickness of the pipes; however, as concerns the climbing device they are identical in their length and in their outside dimension as well as concerns the bolting. It is also conceivable to design the crane tower as a so-called P-Tower in a suitable length, in particular after the lower revolving platform. A P-Construction comprises crane towers that run in parallel at least in sections. The parallelism of the crane towers can be arranged either in the direction of load or transversely to the direction of load. Furthermore, parallel crane towers can run at a distance from or directly adjacent to each other.

The construction as P-Tower makes possible a distinct increase in the carried load with relatively slight additional cost. Crane towers that run in parallel can be brought together to one tower continuously or by means of suitable intermediate pieces. After this point the climbing device can be set on and the tower lengthened into the desired final position. In addition, there is the possibility that the crane tower is split by an intermediate piece into parallel crane towers. The climbing device makes the lengthening of the P-Tower possible.

The crane tower is appropriately provided with a defined stay, as a result of which the forces received from the revolving platform, in particular from the upper, fixed revolving platform are removed via the crane tower. The stay optionally runs along the longitudinal axis of the crane tower.

In a construction with an upper, fixed revolving platform and a lower, rotatable revolving platform it is purposeful that the stay runs from the lower revolving platform to the upper, fixed revolving platform and is articulated at each end to the upper, fixed one and to the lower revolving platform. A single-strand or multi-strand stay is conceivable with an articulation point arranged centrally on the rear of the revolving platform or with two articulation points arranged symmetrically on the revolving platform rear. Analogous stay points are on the upper, fixed revolving platform.

The tower stay can comprise a stay cabling or, alternatively, additional stay rods. At least one stay winch is arranged on the upper revolving platform with which the stay cabling can be tightened or the stay rods can be drawn from the lower revolving platform in the direction of the upper, fixed revolving platform.

It is also conceivable that the stay rods are stored folded on the lower revolving platform. For the constructing of the stay it can be drawn upward via the auxiliary winch of the upper, fixed revolving platform and then appropriately bolted.

The staying of the tower takes place after the achieving of the final working height. As soon as the desired lift height has been reached, the stay is tensioned for producing the maximum carrying load.

One or more lattice pieces can be bolted behind the or additionally laterally on the lower and/or upper, fixed revolving platform for a widening of the lever arm of the stay. The stay no longer has to be directly fastened on the revolving platform but rather can be articulated behind or offset laterally to it on the lattice pieces.

The arm rockably articulated on the tower tip or the upper, fixed revolving platform can be constructed as a telescopic arm or alternatively as a lattice arm.

In addition, the arm construction can be in one piece or in several pieces. The construction as lattice arm would offer a distinct savings of weight in comparison to the telescopable alternative. The resulting weight savings makes higher loads possible. In the case of the construction with a lattice arm the upper, fixed revolving platform can be eliminated and the lattice arm directly bolted to the crane tower via a fitting intermediate piece. In this case the stay and the adjusting are carried out in a manner similar to the previously known lattice stays and lattice adjustments.

The rocking movement of the telescopic arm takes place via one or two rocking cylinders fastened on the upper, fixed revolving platform. In the case of a lattice tip the rocking movement can take place by one or several stay frames. The rocking mechanism for a telescopic arm appropriately comprises at least one rocking cylinder while the movement of a lattice arm takes place via one or several stay frames.

At least one auxiliary winch may be provided on the arm, in particular in the arm area in the vicinity of the tower or on the climbing device, which winch operates in conjunction with the climbing device during the climbing procedure. A lattice piece can be raised by the auxiliary winch and raised up to the transfer point of the climbing device. The main winch is consequently not required for the climbing process and the costly sheering of the lifting cable is superfluous. The necessary lifting work during the climbing procedure is directed almost totally from the auxiliary winch. The auxiliary cable can be run directly from the auxiliary winch to the ground.

The carrier undercarriage of the mobile tower crane can be constructed as a multi-axle crane undercarriage for street traffic or also as a caterpillar traveling mechanism.

One or several storage devices for individual lattice pieces, in particular intermediate lattice pieces for the assembly of the revolving tower crane can be provided on the lower revolving platform and/or on the carrier undercarriage. Non-required lattice pieces can be stored in part directly on the crane and moved jointly to and from the individual locations of use.

It is possible for the lattice pieces stored on the revolving platform and/or the carrier undercarriage to be taken up by the auxiliary winch provided on the arm or at least a large part of the stored lattice can be taken up. In this case no additional auxiliary or assembly embodiment is needed for the construction of the crane. A corresponding storage point is appropriately defined in the direction of load in front of the tower on the revolving platform. Of course, additional storage points can also be provided at any position on the revolving platform or on the carrier undercarriage.

Other advantages and details of the present disclosure will be explained in the following in detail using the figures.

### BRIEF DESCRIPTION OF THE FIGURES

FIG. 1 shows a side view of the mobile revolving tower crane in accordance with the present disclosure.

FIG. 2 shows a front view of the mobile revolving tower crane.

FIG. 3 shows an alternative embodiment of the mobile revolving tower crane in accordance with the present disclosure.

FIG. 4 shows a detailed view of the lower tower element of the revolving tower crane in accordance with the present disclosure.

FIG. 5 shows a lateral view of the revolving tower crane in an alternative construction.

FIG. 6 shows the revolving tower crane of FIG. 5 in a folded moving state. The figures are drawn approximately to scale, although other relative dimensions may be used.

### DETAILED DESCRIPTION

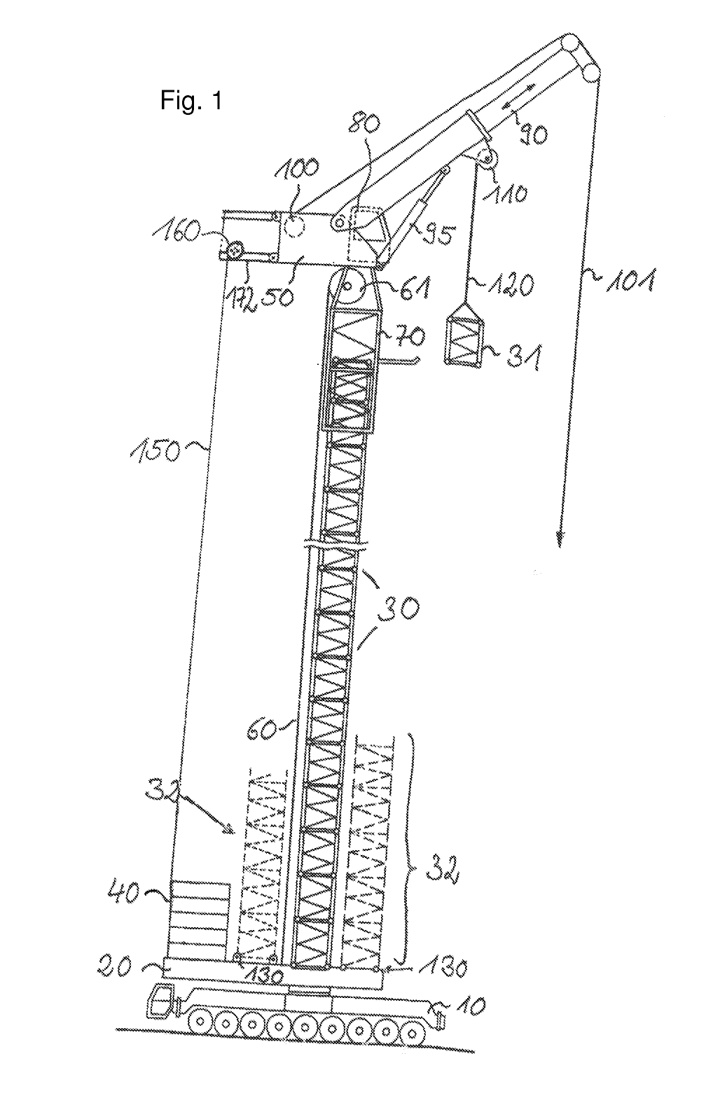

FIG. 1 shows a lateral view of the mobile revolving tower crane in accordance with the present disclosure. A multi-axis crane undercarriage 10 is used as a carrier undercarriage and its top comprises a quick connection for receiving the rotary crown of the revolving platform 20. The revolving platform 20 is rotatably supported about a vertical axis of rotation opposite the crane undercarriage 10. Individual lattice pieces 30 are bolted to each other to a crane tower in the vertical direction on the surface of the revolving platform 20. Individual ballast plates 40 are stacked on the rear of the revolving platform. In addition, a rotary mechanism is located on the revolving platform and serves to generate the rotary movement of the revolving platform 20.

The lowest lattice piece is vertically connected to the revolving platform 20 by screwing or a bolt connection. In the beginning a climbing device 70 can be set on after two to three intermediate pieces 30 of the main tower. The figure view shows the crane after a few climbing procedures have taken place. The climbing device 70 may be structured with a bottom opening to fit over and outside of one or more already constructed lattice pieces in the tower, and may include a ledge adjacent a side opening to receive additional lattice elements that can then be placed on the already constructed lattice tower. Side walls of the climbing device may restrict motion of the climbing device in the vertical direction when fit over the uppermost lattice element of the tower. Further, the climbing device may be structured to push against the uppermost lattice element in order to raise up vertically when extending the height of the tower in a telescoping manner, thus increasing an opening or void within the climbing device in order to receive another lattice element immediately above the current uppermost lattice element via the side opening.

During a climbing procedure an intermediate piece 31 can be introduced in the tower. As a result the actual crane lift height can be adapted to the site of use.

A fixed upper revolving platform 50 is located on the upper end of the tower. This platform contains, in addition to the complete crane drive technology, such as, for example, drive motor, hydraulic pumps, hydraulic frames, etc., also a hydraulic tank and a fuel tank. Furthermore, the necessary electronics of the crane control is arranged on the revolving platform. In addition, a crane cabin 80 is bolted on the upper revolving platform in the exemplary embodiment of FIG. 1. Since the entire crane- and drive technology is supported at a relatively high level, an automatic or alternatively a manually releasable extinguishing device is attached on the revolving platform 50 that extinguishes, in an emergency, the drive- and crane components standing in flames.

The hydraulic supply of the hydraulic revolving platform drive of the lower revolving platform 20 is made available via an oil supply line 60 from the upper, fixed revolving platform 50. The lines 60 run along the longitudinal axis of the tower from the upper, fixed revolving platform 50 to the lower revolving tower 20. For a flexible change of length the supply lines 60 are wound on a hose roll 61 and can be wound on or off manually or automatically during the climbing procedure.

The revolving platform 50 is rigid with the crane tower and can therefore not rotate relative to the revolving platform 20. Concretely speaking, the latter is firmly connected to the climbing device 70 during the climbing procedure and during the lifting operation it is firmly connected to the tower tip, i.e., to the uppermost lattice piece.

Furthermore, the upper, fixed revolving platform 50 serves to receive the crane arm 90, that is supported in such a manner that it can rock around a horizontal pivot axis on the upper, fixed revolving platform 50. The rocking movement is produced by the rocking cylinder 95 that extends from the front side of the fixed revolving platform 50 to the arm 90. In addition, the revolving platform 50 comprises the lifting mechanism in the form of a cable lifting winch 100 whose lifting cable 101 runs along the arm 90 of the roll head on the arm tip.

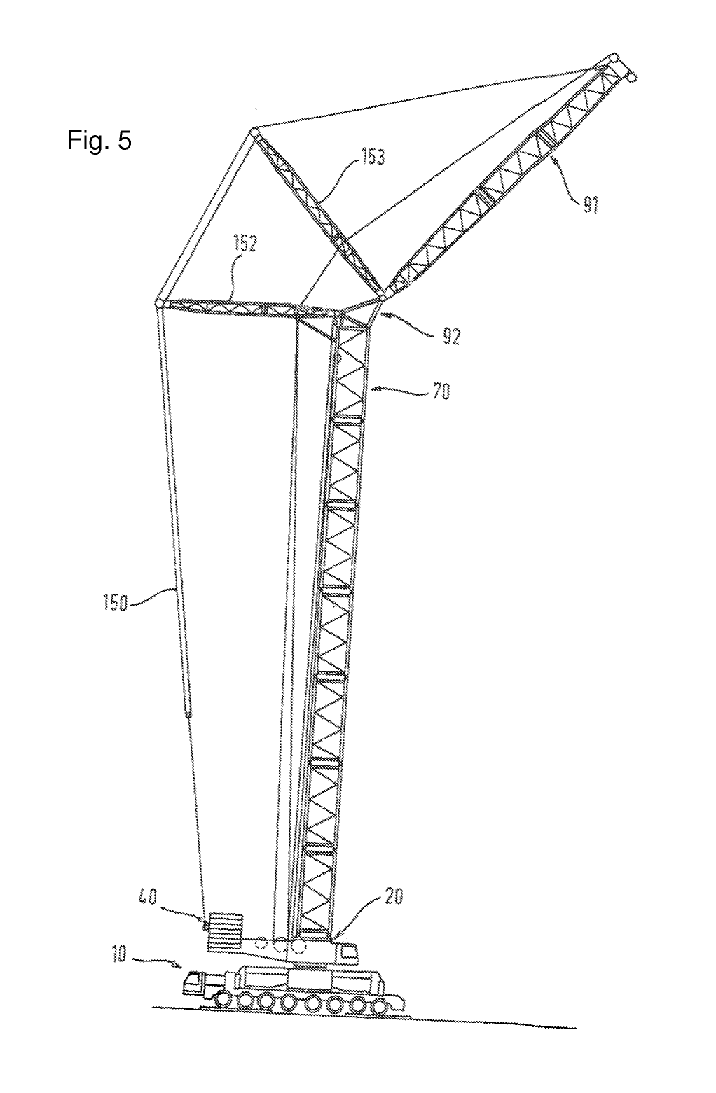

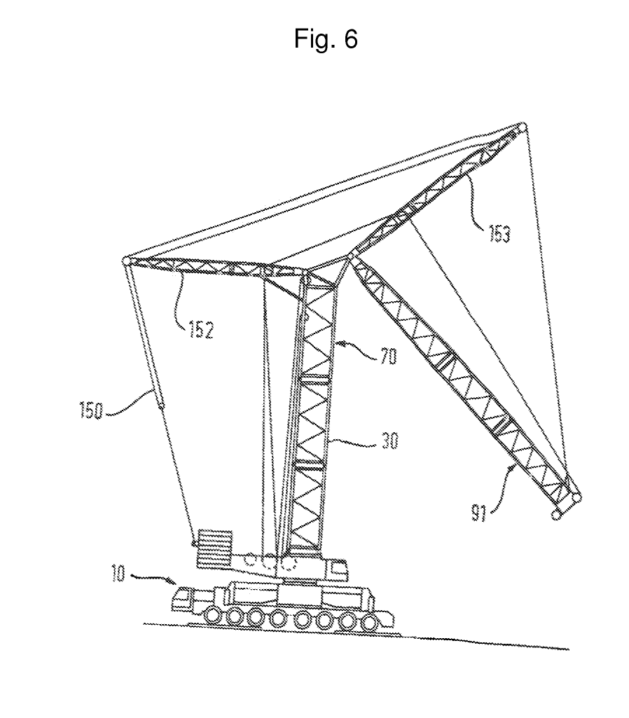

The arm 90 is constructed as a telescopic arm, wherein in FIG. 1 only a telescopic length and the articulation piece are represented. However, the design of the arm can comprise several telescopic lengths. Alternatively, the arm shown can also be constructed to be in a single part, multi-partite or as a lattice arm 91 (see FIGS. 5, 6).

An auxiliary winch 110 is provided below the arm from which an auxiliary cable 120 can be let down to the lower revolving platform 20 and at least one intermediate piece 31 for the tower crane can be taken up. The lattice pieces 31 required for the climbing procedure can be readily raised by the auxiliary winch 110 from the ground to the transfer point of the climbing device 70. Alternatively, this auxiliary winch 110 can also be attached to the climbing device 70.

In order to move the crane to a next close site of use after a complete construction and completed lift, the crane can be appropriately disassembled or reduced to its admissible moving weight. The center of gravity for the height must also be considered here. The disassembled intermediate lattice pieces 32 can ideally be stacked on the revolving platform 20 or on a bolted-on carrier 130, as a result of which the crane can move its lattice pieces at least in part independently. The lattice pieces can be independently disassembled, stacked up and bolted down in the front area of the revolving platform 20 since the auxiliary cable 120 can be let down to this storage position on the revolving platform. Ideally, more space for stacking individual lattice pieces is available in the rear area of the revolving platform 20. Since the auxiliary winch 110 cannot reach this storage area with the auxiliary cable 120, a separate auxiliary crane is required to this end. On the other hand, the intermediate pieces can also be brought to the next site of use with a separate transport.

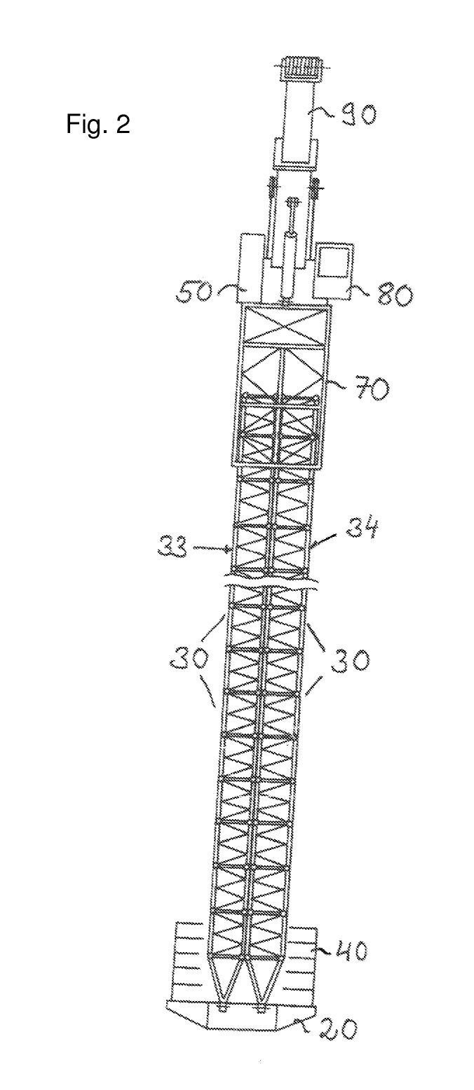

FIG. 2 shows a front view of the mobile tower crane in accordance with the present disclosure, wherein in contrast to the view in FIG. 1 the tower crane is constructed as a so-called P-Tower. The latter consists of two tower strands 33, 34 running in parallel and arranged laterally offset adjacent to one another transversely to the direction of load. The separate tower strands run over the entire tower length from the revolving platform 20 to the upper, fixed revolving platform 50. A distinct increase of the carrying load of the crane is achieved by the construction of the tower crane as a P-Tower by simple means and relatively low expense. A lengthening of the P-Tower during the climbing procedure is readily possible, wherein two lattice pieces 30 are set on in parallel or individually by the climbing device.

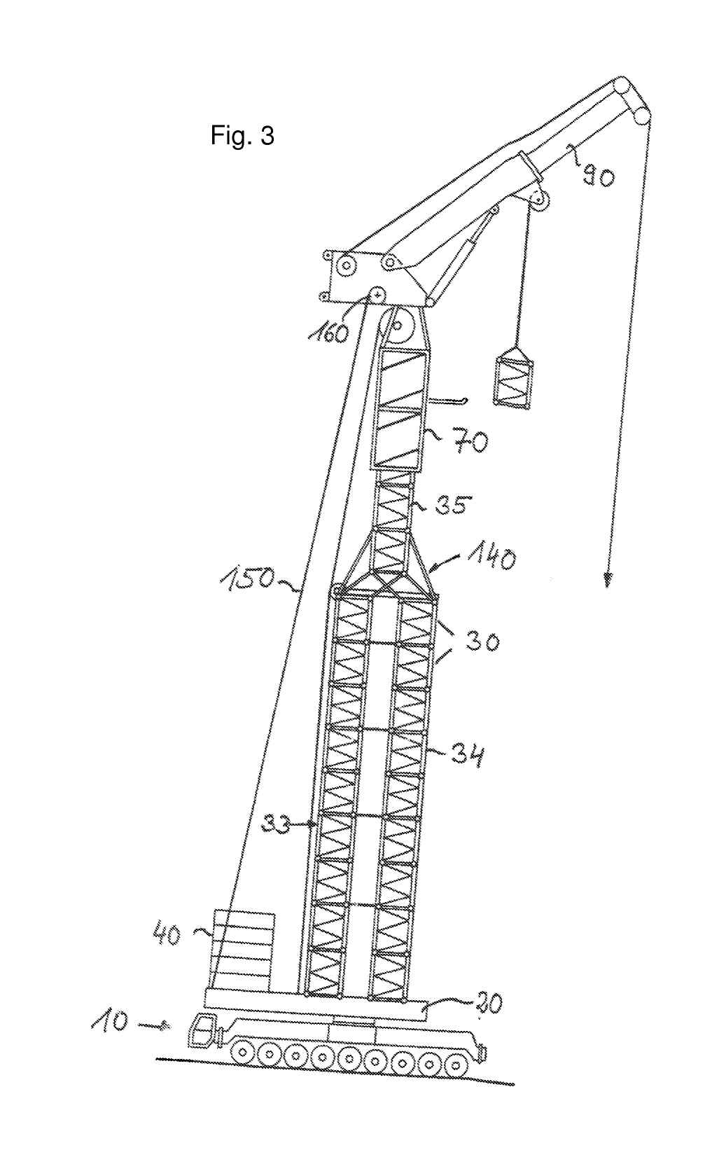

Alternatively, the crane can also be constructed with a P-Tower whose sections running in parallel are arranged in parallel in the direction of the load. FIG. 3 shows an example of this. The two crane towers 33, 34 extend vertically from the lower revolving platform 20 to an intermediate piece 140 that brings the two parallel towers 33, 34 together and combines them to a single tower strand 35. The upper, fixed revolving platform 50 is arranged on the upper tip of the combined tower strand 35 in analogy with the design in FIG. 1.

In all embodiments one centrally attached stay point or alternatively two laterally attached stay points are provided on the rear area of the revolving platform 20. In analogy to this, corresponding counter-stay points are present on the upper, fixed revolving platform 50. The defined tower stay runs from the lower revolving platform 20 to the upper, fixed revolving platform 50 and serves as a stay for the entire tower crane. The stay takes place independently of the design of the crane, i.e., as a simple main tower or as a P-Tower. The stay 150 takes place either by cable, that is sheered in appropriately frequently according to its loadability, or with the aid of stay rods.

In as far as stay rods are used, they can be stored folded on the lower revolving platform 20 and drawn in the direction of the upper, fixed revolving platform 50 as needed by at least one or alternatively two stay winches 160 arranged on the upper, fixed revolving platform 50 and bolted in a defined manner on this revolving platform.

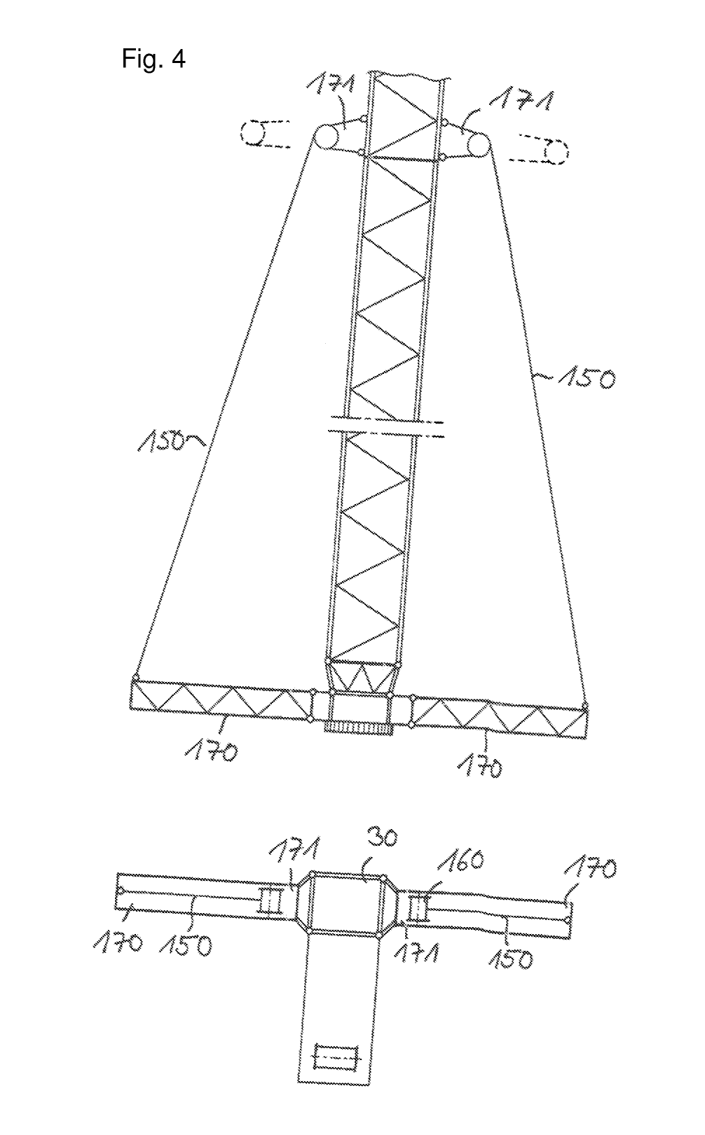

The stay always takes place after the reaching of the working height of the crane tower. In order to obtain a corresponding lever arm for the stay, individual lattice pieces 170, 171 can be bolted to the rear (FIG. 1) or laterally (FIG. 4) on the revolving platform 20 and on the fixed revolving platform 50 as needed. An example for this can be gathered from FIG. 4, that shows a rear view and a top view onto the crane tower. This view shows the lower revolving platform 20, on whose side surfaces lattice pieces 170 are bolted and extend vertically from the side surface of the revolving platform 20 and transversely to the direction of load. The stay 150 is bolted on the particular outer end of the bolted-on lattice pieces 170 and runs to the stay winches 160 of the upper, fixed revolving platform 50. The upper bolting-on points can also be shifted outwards by lattice pieces 171 bolted laterally on the upper revolving platform. In contrast thereto, in FIG. 1 a lattice piece 172 is bolted in the rear to the revolving platform 50 for receiving the stay winch 160.

If a rocking tip 91 is mounted instead of the telescopic arm, the upper, fixed revolving platform can be eliminated, as is apparent from FIG. 5. The binding of the stay frames 152, 153 on the rocking tip 91 takes place, as is known, on an intermediate lattice piece 92 appropriately provided to this end. This intermediate piece 92 is firmly bolted to the upper lattice piece. The entire crane operation is housed during the use of the rocking tip 91 in the lower revolving platform 20. The drive for the lifting- and adjusting winches can take place hydraulically or electrically. For moving the crane on the construction site the crane tower is reduced in height and the rocking tip 91 folded down. As a consequence, the entire center of gravity moves down and the crane can be safely moved on the construction site.

Alternatively, the upper carriage motor can be eliminated in both embodiments and the crane operation carried out with the lower carriage motor. The drive can take place mechanically (as is known via articulated shafts) or also hydraulically.

In one example, a method of operating and reconfiguring a crane, such described herein and including any one or more of the crane features described herein, is provided. The method may include reconfiguring the crane from a deconstructed, lower state to an erected state by sequentially adding additional lattice elements on one another. For example, the method may include operating a mobile revolving tower crane with a crane tower comprising individual lattice pieces and with a main arm that is articulated in a rockable manner to the tower via a rocking mechanism, and/or with a rockable tip, wherein the crane tower comprises a climbing device. At least one lower revolving platform may be arranged on a carrier undercarriage of the crane, wherein a quick connection for receiving the rotary crown of the revolving platform is provided on the carrier undercarriage and/or at least one upper, fixed revolving platform is provided on the tower tip, wherein the upper, fixed revolving platform and the lower revolving platform cannot rotate relative to one another and are not rotated relative to each other during any operation of the crane. The method may further include connecting the upper, fixed revolving platform, during a climbing procedure, firmly to the climbing device; and firmly connecting it to the uppermost lattice piece of the tower during the lifting operation. The method may further include raising the tower lattice pieces to a transfer point on the climbing device via at least one auxiliary winch provided on the arm or on the climbing device. The method may further include storing the lattice pieces in one or more storage devices provided on the lower revolving platform and/or on the carrier undercarriage, wherein the method further includes receiving or depositing the storable lattice pieces at least partially by the auxiliary winch. Further, the method may include increasing safety of the crane and moving the crane, where increasing safety includes one or more of reducing the tower height and folding the rocking tip down in order to shift a total center of gravity downward.

1. A mobile revolving tower crane with a crane tower comprising individual lattice pieces and with a main arm that is articulated in a rockable manner to the tower via a rocking mechanism, and/or with a rockable tip, wherein the crane tower comprises a climbing device.

2. The revolving tower crane according to claim 1, wherein the crane is constructed as a bottom slewing crane.

3. The revolving tower crane according to claim 1, wherein at least one lower revolving platform is arranged on a carrier undercarriage of the crane, wherein a quick connection for receiving the rotary crown of the revolving platform is provided on the carrier undercarriage, and/or at least one upper, fixed revolving platform is provided on the rockable tip.

4. The revolving tower crane according to claim 3, wherein the upper, fixed revolving platform and the lower revolving platform cannot rotate relative to one another.

5. The revolving tower crane according to claim 4, wherein the upper, fixed revolving platform is connected during a climbing procedure firmly to the climbing device and during a lifting operation the upper, fixed revolving platform is firmly connected to an uppermost lattice piece of the tower.

6. The revolving tower crane according to claim 5, wherein a crane drive is arranged completely on the upper, fixed revolving platform and wherein an energy supply of the rotating mechanism of the lower revolving platform is positioned on the upper revolving platform.

7. The revolving tower crane according to claim 3, wherein at least one extinguishing device is provided on the upper revolving platform.

8. The revolving tower crane according to claim 1, wherein the tower is constructed at least partially as a P-Tower, in a direction of load or transversely to the direction of load.

9. The revolving tower crane according to claim 3, wherein a device for staying the crane tower is provided that runs from the upper to the lower revolving platform.

10. The revolving tower crane according to claim 9, wherein one or more lattice pieces are arranged on a rear and/or laterally on the upper and/or lower revolving platform for receiving the device for staying.

11. The revolving tower crane according to claim 1, wherein the main crane arm is in one-piece or multipartite and is constructed as a telescopic arm.

12. The revolving tower crane according to claim 1, wherein the main crane arm is in one-piece or multipartite and is constructed as a lattice arm.

13. The revolving tower crane according to claim 1, wherein at least one auxiliary winch is provided on the arm or on the climbing device and serves to raise tower lattice pieces to a transfer point on the climbing device.

14. The revolving tower crane according to claim 3, wherein the carrier undercarriage is a multi-axle crane undercarriage or a caterpillar undercarriage.

15. The revolving tower crane according to claim 14, wherein one or more storage devices for lattice pieces are provided on the lower revolving platform and/or on the carrier undercarriage, wherein the storable lattice pieces are receivable or depositable at least partially by the auxiliary winch.

16. The revolving tower crane according to claim 1, wherein a receptacle for the rocking tip is provided on a tower end that is mountable without a telescopic arm and without an upper, fixed revolving platform with associated stay frames.

17. The revolving tower crane according to claim 16, wherein an entire crane drive is arranged on the lower revolving platform, wherein the crane drive comprises electrical and/or hydraulic components.

18. The revolving tower crane according to claim 17, wherein the tower height is reduceable and the rocking tip is foldable down in order to shift a total center of gravity downward for safely moving the tower.

19. A mobile revolving tower crane, comprising:
a crane tower comprising individual lattice pieces separable from one another;
a main arm that is articulated in a rockable manner about a rotation axis to the tower via a rocking mechanism with a rocking tip; and
a climbing device fitting over an uppermost lattice of the tower and only vertically movable relative to the tower when fit over the upper most lattice, the rotation axis of the rockable arm positioned vertically above the climbing device.

20. The revolving tower crane according to claim 19, further comprising at least one lower revolving platform arranged on a carrier undercarriage of the crane, wherein a quick connection for receiving a rotary crown of the revolving platform is provided on the carrier undercarriage, and at least one upper, fixed revolving platform is provided on the rockable tip, and wherein vertical raising of the climbing device is powered via a line extending from the climbing device to the carrier undercarriage.
